(19) United States
(12) Patent Application Publication
(10) Pub. No.: US 2013/0033223 A1
(43) Pub. Date: Feb. 7, 2013

(54) PORTABLE CHARGER

(71) Applicant: Chih-Hung LIU, Taichung City (TW)

(72) Inventor: Chih-Hung LIU, Taichung City (TW)

(21) Appl. No.: 13/195,278

(22) Filed: Aug. 1, 2011

(51) Int. Cl. H02J 7/00

(52) U.S. Cl. 320/107

(57) ABSTRACT

The present invention provides a portable charger including a shell, a manual electricity generator assembly, an electricity supplier, a USB slot. The shell includes a battery assembly which is used to contain at least one rechargeable battery. The manual electricity generator assembly includes a manual driving device and an electricity generation mechanism, the manual driving device has one end connecting to the electricity generation mechanism, the electricity generation mechanism connecting to the battery assembly electrically. The electricity supplier and the USB slot connect to the battery assembly electrically. According to conditions, users can choose to recharge by the electricity supplier or the manual electricity generator assembly. Besides, the USB slot is capable of offering electricity to appliances with a USB plug. Therefore, the portable charger of the present invention can not only recharge for rechargeable batteries, but have more multi-purpose. As such, the practicability is increased as well.

### BACKGROUND OF THE INVENTION

1. Field of the Invention

The present invention relates to the field of a charger, and more particularly to a portable charger with multi-purpose capable of providing charging functions for rechargeable batteries.

2. Description of the Prior Art

With a technology trend that shapes electronic products in ways of lighter, thinner, shorter and smaller, portable electronic products matching with environmental regulations become more and more. As we can know, the portable electronic products are offered with rechargeable batteries which need a charger for recharging. Conventional chargers mainly use an alternating current to offer electricity to a charger through a transformer.

However, the conventional chargers can be used only when an electricity outlet is provided. When the chargers are used outdoors, the electricity outlet is not available easily. Once users' portable products run out of electricity, there's nothing users can do or having a rechargeable batteries at hands.

Moreover, the conventional chargers can provide only a function of charging for rechargeable batteries. A charger can play the function of charging only when a battery runs out of electricity. From economical aspect viewpoints, leaving the conventional charger unused in most of time shows a low use rate and is not match with the economical viewpoints.

On the other hand, although various forms of conventional chargers have been provided in the consumer market, sizes of rechargeable batteries are too many. Thus, the conventional chargers are not applicable enough, and the efficiency of charging would be limited by the style of batteries as well.

### SUMMARY OF THE INVENTION

The main object of the present invention is to provide a portable charger which can offer electricity to electronic appliances and with charging function at anytime.

To achieve the above, the present invention provides a portable charger including a shell, a manual electricity generator assembly, an electricity supplier and a USB slot. The shell comprises a battery assembly which is used to contain at least one rechargeable battery. The manual electricity generator assembly, disposed in the shell, comprises a manual driving device and an electricity generation mechanism. The manual driving device has one end for users' hands to hold and another end connecting to the electricity generation mechanism. The electricity generation mechanism connects to the battery assembly electrically. One end of the manual driving device drives the electricity generation mechanism to generate electricity when users' hands drive another end of the manual driving device. The electricity generation mechanism conveys electricity to the rechargeable battery in the battery assembly. The USB slot, positioned on the shell, connects to the battery assembly electrically. A USB plug of an electric appliance can be disposed in the USB slot.

Users can charge devices with electricity with an outlet. Also, users can charge devices with the manual electricity generation assembly, and the USB slot can offer electricity to electric appliances with USB plugs. As such, the portable charger of the present invention can charge for rechargeable batteries at anytime and anywhere. The portable charger of the present invention has features of multi-purpose and practicability.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a preferred embodiment of the present invention;

FIG. 2 is a schematic drawing showing a charger application of providing electricity to an electric fan and in accordance with a preferred embodiment of the present invention;

FIG. 3 is a schematic drawing showing actions of manual charging in accordance with a preferred embodiment of the present invention;

FIG. 4 is a schematic drawing showing actions that the pushing block positions the pushing shank at the second position in accordance with a preferred embodiment of the present invention;

FIG. 5 is a schematic view showing a charger application on a cell-phone in accordance with a preferred embodiment of the present invention;

FIG. 6 is a schematic view showing a supply of electricity to a lighting device with LED bulbs in accordance with a preferred embodiment of the present invention;

FIG. 7 is a schematic view showing a supply of electricity to a GPS device in accordance with a preferred embodiment of the present invention.

### DETAILED DESCRIPTION OF THE PREFERRED EMBODIMENTS

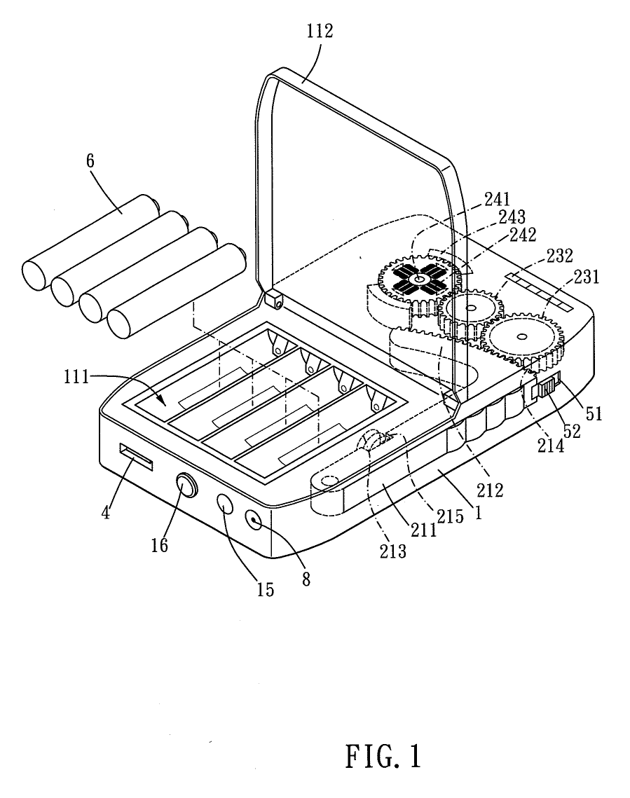

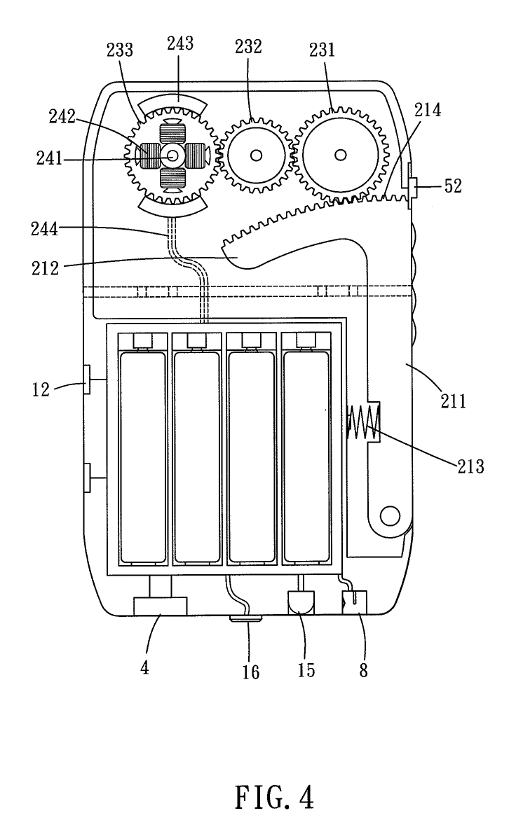

Please refer to FIG. 1 and FIG. 4, the portable charger of the present invention includes a shell 1, a manual electricity generator assembly, an electricity supplier 3, a USB slot 4 and a positioning device.

The shell 1 comprises a battery assembly which is used to contain at least one rechargeable battery. In a preferred embodiment of the present invention, the battery assembly includes a battery container 111 and a lid 112, the rechargeable battery 6 is disposed in the battery container 111, and the lid 112 is positioned on the battery container 111 so that the rechargeable battery 6 would not fall out from the shell 1.

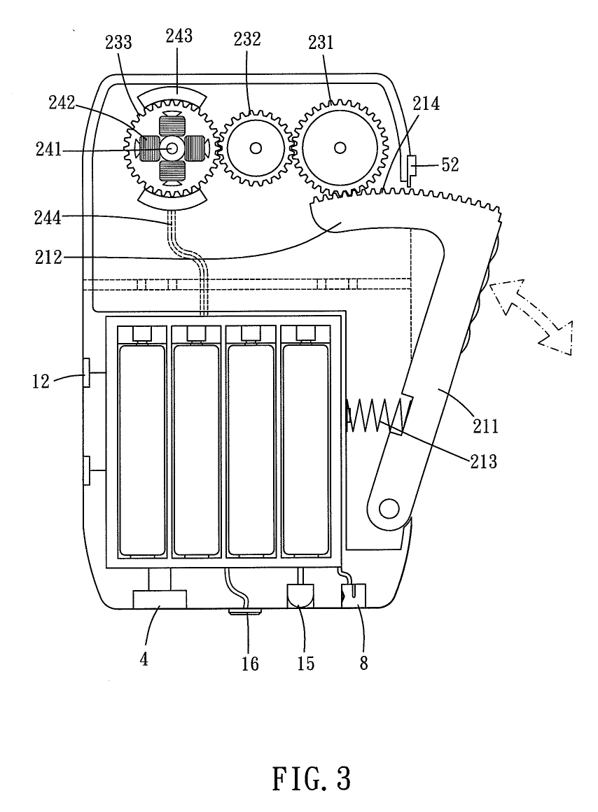

The manual electricity generator assembly is disposed in the shell 1. The manual electricity generator assembly includes a manual driving device and an electricity generation mechanism. The manual driving device has one end for users to hold and another end connecting to the electricity generation mechanism which is connecting to the battery assembly electrically. In the preferred embodiment of the present invention, the manual driving device includes a pushing shank 211, a driving portion 212 and an elastic member 213. One end of the pushing shank 211 is pivotally positioned on the shell 1, and another end of the pushing shank 211 connects to the driving portion 212. The pushing shank 211 pivots between a first position and a second position. The driving portion 212 has plural convex teeth 214. One end of the elastic member 213 is disposed in the pushing shank 211, and another end of the elastic member 213 is disposed in the shell 1 so that the pushing shank 211 has a tendency of moving toward the first position anytime. In a preferred embodiment, the pushing shank 211 has a containing space 215 for one end of the elastic member 213 to dispose therein. The containing space 215 is located on one side that the pushing shank 211 faces an inner side of the shell 1. In the preferred embodiment of the present invention, the elastic member 213 is a spring. However, types of the elastic member 213 are not limited only by the spring. The electricity generation mechanism comprises a transmission device and an electricity generation device. One end of the transmission device engages with the driving portion, and another end of the transmission device fabricates in the electricity generation device. The transmission device is disposed between the driving portion and the electricity generation device. The transmission device is rotatable. The electricity generation device connects to the battery assembly electrically. The driving device comprises a first gear 231, a second gear 232 and a third gear 233. The driving portion 212 engages with the first gear 231, and the second gear 232 engages between the first gear 231 and the third gear 233. The electricity generation device comprises a rotor 241, plural coil assemblies 242 and at least one stator magnet 243. The rotor 241 is rotational disposed in the third gear 233, and the coil assemblies 242 are positioned between the stator magnet 243 and the rotor 241. The coil assemblies 242, connecting to the battery assembly electrically, are disposed around the rotor 41. Moreover, when one end of the manual driving device is driven by users' hands, another end of the manual driving device drives the electricity generation mechanism to generate electricity, and the electricity generation mechanism conveys the electricity to rechargeable batteries in the battery assembly. To be more specific, users can hold the shell 1 by one hand with fingers pushing the pushing shank 211. When the pushing shank 211 pivots to the second position, the first gear 231 and the second gear 232 are drove to rotate. And the second gear 232 drives the third gear 233 to rotate. The third gear 233 drives the rotor 241 to rotate. When the rotor 241 rotates, a magnet field passing through the coil assembly 241 is changed so as to generate electricity. As shown in FIG. 3 and FIG. 4, the electricity can be conveyed by a leading wire 244 to the battery assembly, and then rechargeable batteries in the battery assembly can gain electricity.

The electricity supplier 3 comprises a plug 31 on one end, the plug 31 is offered to be disposed in an outlet, and another end of the plug 31 connects to the battery assembly electrically. In the preferred embodiment of the present invention, another end of the electricity supplier 3 has an adaptor, and the shell 1 includes a jack 12, and the adaptor can be disposed in the jack 12 with connecting to the battery assembly electrically. In other possible embodiments of the present invention, another end of the electricity supplier can connect to the shell directly, too.

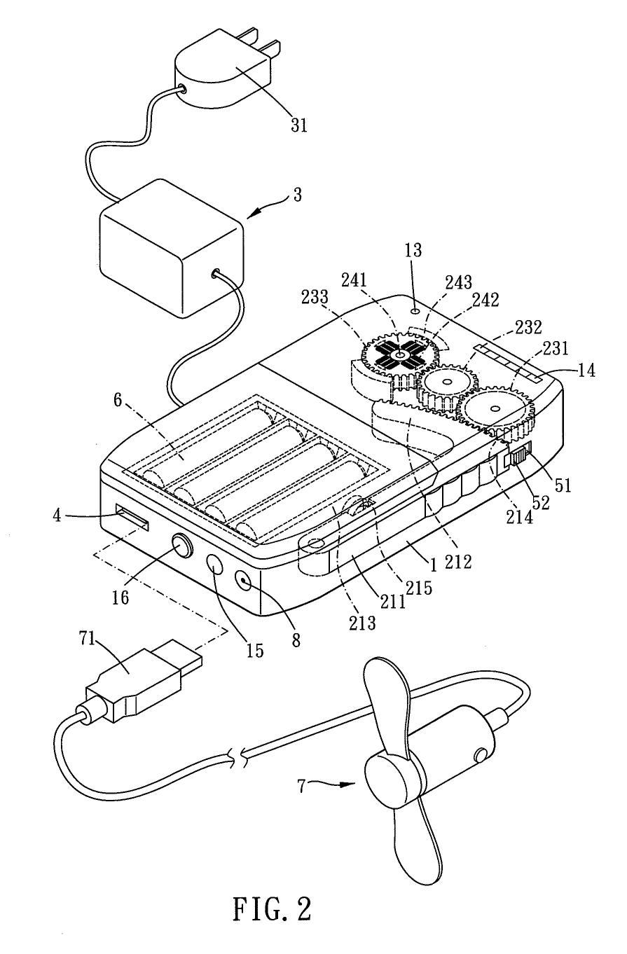

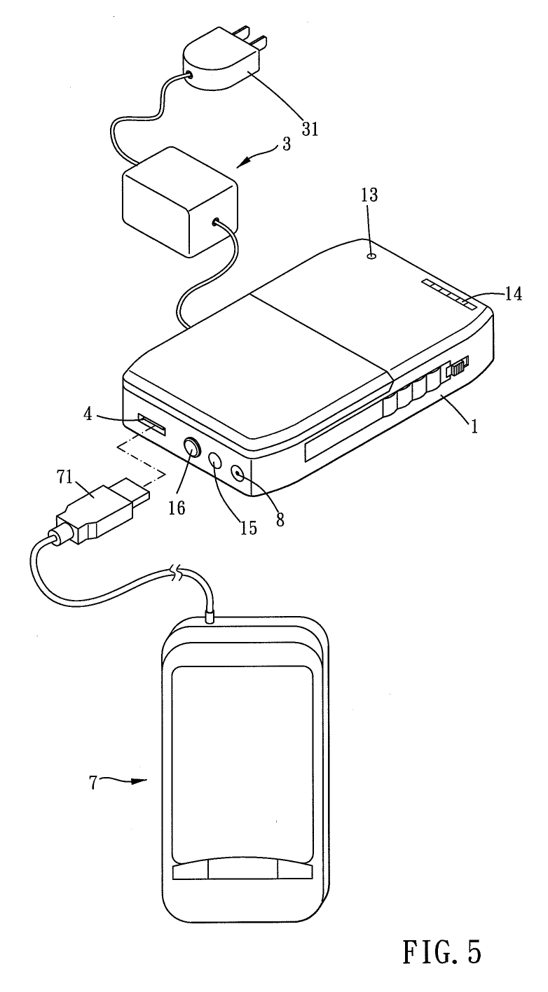

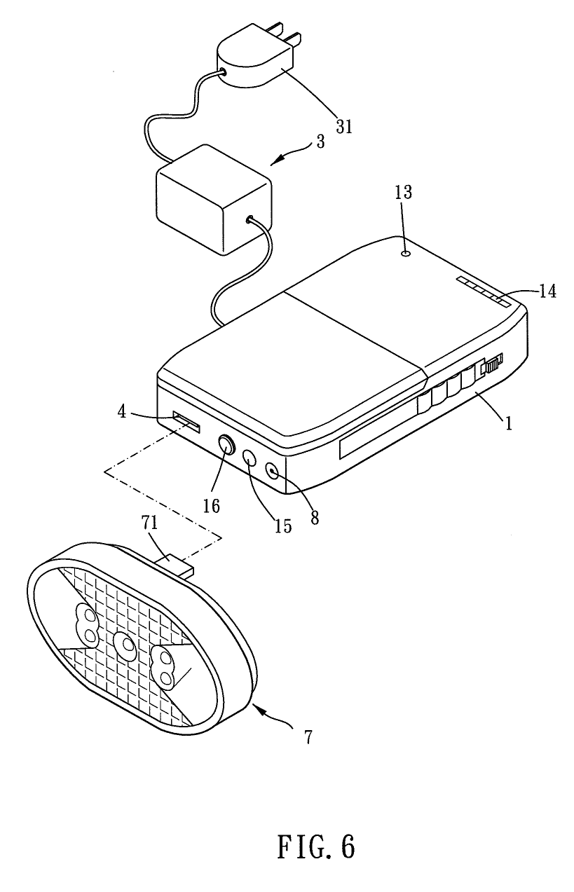

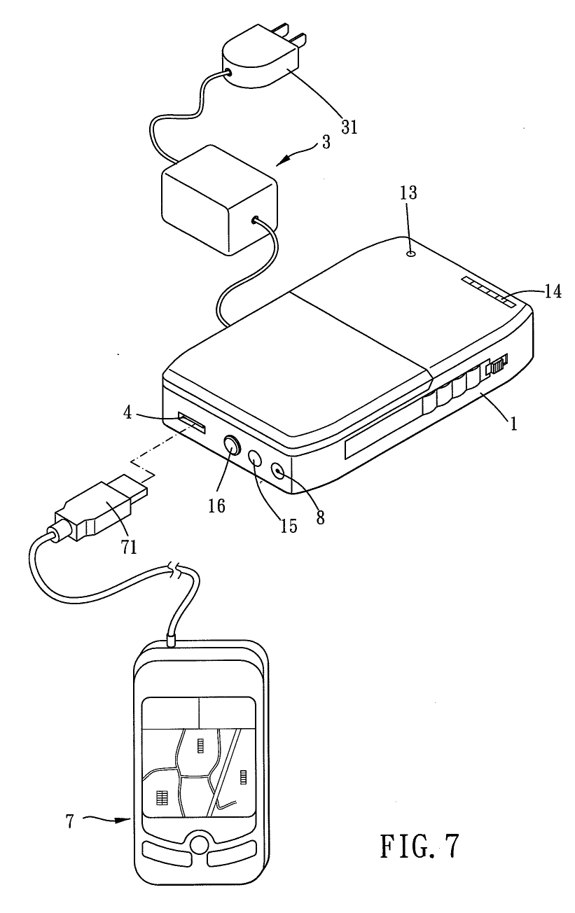

The USB slot 4, being positioned on the shell 1, is connecting to the battery assembly electrically, and the USB slot 4 being used by an electric appliance 7 with a USB plug. The electric appliance 7 can gain electricity by inserting the USB plug in the USB slot 4. In the preferred embodiment of the present invention, as shown in FIG. 2, FIG. 5, FIG. 6 and FIG. 7, the electric appliance 7 with a USB plug can be an electric fan, a cell-phone, a lighting device with a LED bulb, or a GPS. Of course, the electric appliance 7 with a USB plug can be other types of electric appliances, being unlimited by examples mentioned above.

The positioning device, being disposed on the shell 1, fixes the pushing shank 211 at the second position selectively. The positioning device comprises a sliding channel 51 and a pushing block 52. The sliding channel 51 is located in one side of the shell 1. The pushing block 52 is disposed in the sliding channel 51 movably, and the pushing block 52 fixes the pushing shank 211 at the sliding channel selectively. As such, when users do not use the manual electricity generator assembly to charge, the manual electricity generator assembly can be received in the shell 1.

Normal users often bring electric appliances such as cell-phone and GPS when they go out. As soon as rechargeable batteries of electric appliances run out of electricity, rechargeable batteries can be put in the battery container of the present invention, disposing the plug of the electric appliance in a jack so that the rechargeable batteries can be recharged to regain electricity. When users could not find any jack or in an outdoor environment, or even suffer from disasters such as earthquakes or flood so that a lack of electricity occurs, users can use the portable charger by one hand holding the shell, pushing the pushing shank to make the driving portion drive the transmission device. Therefore, the electricity generation device which is driven by the transmission device can generate electricity and convey the electricity to rechargeable batteries in the battery assembly. The portable charger of the present invention can charge for rechargeable batteries at anytime and anywhere without limiting by any condition.

Besides, after finishing the charging process, the conventional charger is placed aside with ignorance. The portable charger with the USB slot of the present invention can offer electricity to any electric appliance with USB plug. Of course, some electric appliances have electricity transmission wires instead of USB plugs. Thus, the present invention has an extra electricity outlet 8. The electricity outlet 8 is disposed in the shell 1. As shown in FIG. 2, the electricity outlet 8 connects to the battery assembly electrically. The electric appliance connects with the electricity outlet 8 by the electricity transmission wire. Thus, the portable charger of the present invention can offer electricity to the electric appliances with USB plugs or electricity transmission wires, increasing practicability of the portable charger of the present invention. Furthermore, the LED lighting device is a LED bulb with several types of lighting modes. One of the lighting modes is a high-brightness mode, and another type is a twinkling mode of warning. The high-brightness mode is used in the dark or in the wild, waiting for rescue. The twinkling mode of warning can be used to inform a rescue team of victims' location.

On the other hand, sizes of the rechargeable batteries are various, so single size of the battery assembly is not enough to fit all sizes of batteries. Because the present invention has a USB slot, users only have to dispose the USB plug of an electric appliance with rechargeable batteries in the USB slot for charging. Users do not have to worry about problems of size, and the charging efficiency is also stable.

The shell 1 of the present invention further comprises a charging display device 13 and a display device of electric quantity 14. The charging display device 13 connects to the battery assembly electrically for showing charging conditions of the rechargeable battery 6. The display device of electric quantity 14 connects to the battery assembly electrically for showing total electric quantity of the rechargeable battery 6. As such, users can be informed of the quantity of the rechargeable battery 6 at any time.

Surely, the portable charger of the present invention has more use purposes. For instance, the shell 1 has at least one LED bulb 15 and a switch 16. The switch 16 can be used to electrically connect the LED bulb 15 with the battery assembly selectively. As a result, the portable charger of the present invention can be used as a flashlight as well.

What is claimed is:

1. A portable charger, comprising:
a shell, comprising a battery assembly which is used to contain at least one rechargeable battery;
a manual electricity generator assembly, disposed in the shell, comprising a manual driving device and an electricity generation mechanism, the manual driving device having one end for users' hands and another end connecting to the electricity generation mechanism, the electricity generation mechanism connecting to the battery assembly electrically; wherein one end of the manual drives device driving the electricity generation mechanism to generate electricity when users' hands driving another end, of the manual driving device, the electricity generation mechanism conveying electricity to the rechargeable battery in the battery assembly;
an electricity supplier, comprising a plug on one end, the electricity supplier being inserted in an outlet, and another end of the supplier connecting to the battery assembly electrically; and
a USB slot, positioned on the shell, the USB slot connecting to the battery assembly electrically, the USB slot being used by an electric appliance with a USB plug.

2. The portable charger of claim 1, wherein the shell comprises a charging display device, the charging display device connects to the battery assembly electrically, the charging display device shows a status of charging.

3. The portable charger of claim 1, wherein the shell comprises a display device of electric quantity, the display device of electric quantity connects to the battery assembly electrically, the display device of electric quantity shows a total electric quantity.

4. The portable charger of claim 1, wherein the shell comprises at least one LED bulb and a switch, the switch makes the LED bulb connect to the battery assembly electrically, the switch makes the LED bulb connect to the battery assembly selectively.

5. The portable charger of claim 1, wherein the portable charger further comprises an outlet hole of electricity, the outlet hole of electricity is disposed on the shell, and the outlet hole of electricity connects to the battery assembly electrically, the outlet hole of electricity is adapted by an electric appliance with a transmission wire.

6. The portable charger of claim 1, wherein the manual driving device comprises a pushing shank and a driving portion, one end of the pushing shank is pivotally positioned on the shell, another end of the pushing shank connects to the driving portion, the pushing shank swings between a first position and a second position, the driving portion has plural convex teeth, the electricity generation mechanism comprises a transmission device and an electricity generation device, one end of the transmission device engages with the driving portion, another end of the transmission device fabricates in the electricity generation device, the transmission device is rotational disposed between the driving portion and the electricity generation device, the electricity generation device connects to the battery assembly electrically.

7. The portable charger of claim 2, wherein the manual driving device comprises a pushing shank and a driving portion, one end of the pushing shank is pivotally positioned on the shell, another end of the pushing shank connects to the driving portion, the pushing shank swings between a first position and a second position, the driving portion has plural convex teeth, the electricity generation mechanism comprises a transmission device and an electricity generation device, one end of the transmission device engages with the driving portion, another end of the transmission device fabricates in the electricity generation device, the transmission device is rotational disposed between the driving portion and the electricity generation device, the electricity generation device connects to the battery assembly electrically.

8. The portable charger of claim 6, wherein the manual driving device comprises an elastic member, one end of the elastic member is disposed in the pushing shank, and another end of the elastic member is disposed in the shell so that the pushing shank has a tendency of moving toward the first position anytime.

9. The portable charger of claim 7, wherein the manual driving device comprises an elastic member, one end of the elastic member is disposed in the pushing shank, and another end of the elastic member is disposed in the shell so that the pushing shank has a tendency of moving toward the first position anytime.

10. The portable charger of claim 8, wherein the pushing shank has a containing space for one end of the elastic member to dispose therein, the containing space is located on one side that the pushing shank faces an inner side of the shell.

11. The portable charger of claim 9, wherein the pushing shank has a containing space for one end of the elastic member to dispose therein, the containing space is formed on one side that the pushing shank faces an inner side of the shell.

12. The portable charger of claim 8, wherein the portable charger further comprises a positioning device, the positioning device is disposed on the shell, the positioning device fixes the pushing shank at the second position selectively.

13. The portable charger of claim 9, wherein the portable charger further comprises a positioning device, the positioning device is disposed on the shell, the positioning device fixes the pushing shank at the second position selectively.

14. The portable charger of claim 12, wherein the positioning device comprises a sliding channel and a pushing block, the pushing block is disposed in the sliding channel movably, and the pushing block fixes the pushing shank at the second position selectively.

15. The portable charger of claim 13, wherein the positioning device comprises a sliding channel and a pushing block, the pushing block is disposed in the sliding channel movably, and the pushing block fixes the pushing shank at the second position selectively.

16. The portable charger of claim 6, wherein the driving device comprises a first gear, a second gear and a third gear, the driving portion engages with the first gear, the second gear engages between the first gear and the third gear, electricity generation device comprises a rotor, plural coil assemblies and at least one stator magnet, the rotor is rotational disposed in the third gear, the coil assemblies are positioned between the stator magnet and the rotor, the coil assemblies are disposed around the rotor, and connecting to the battery assembly electrically.

17. The portable charger of claim 7, wherein the driving device comprises a first gear, a second gear and a third gear, the driving portion engages with the first gear, the second gear engages between the first gear and the third gear, electricity generation device comprises a rotor, plural coil assemblies and at least one stator magnet, the rotor is rotational disposed in the third gear, the coil assemblies are positioned between the stator magnet and the rotor, the coil assembly are disposed around the rotor, and connecting to the battery assembly electrically.
